(19) United States
(12) Patent Application Publication
(10) Pub. No.: US 2026/0254113 A1
(43) Pub. Date: Aug. 27, 2026

(54) REFLECTOR

(71) Applicant: Nitto Denko Corporation, Osaka (JP)

(72) Inventors: Naoki NAGAOKA, Osaka (JP); Daiki KATO, Osaka (JP)

(21) Appl. No.: 19/160,211

(22) PCT Filed: Mar. 28, 2024
(86) PCT No.: PCT/JP2024/012860

§ 371 Date: Aug. 27, 2025

(30) Foreign Application Priority Data
Mar. 31, 2023 (JP) 2023-058657

(51) Int. Cl. H01Q 3/46

(52) U.S. Cl. CPC H01Q 3/46

(57) ABSTRACT

One object of the present invention is to provide a reflector in which a beam diameter of a main lobe of reflected waves in a target direction is enlarged. The reflector includes a dielectric layer, a conductive layer formed on a first surface of the dielectric layer and including a plurality of conductive patterns that reflect incident waves, and a ground layer formed on a second surface of the dielectric layer opposite to the first surface, wherein the plurality of the conductive patterns is disposed along a predetermined direction, and a standard deviations σ of a difference between an ideal distance and a center-to-center distances between centers of a reference conductive pattern and an arbitrary conductive pattern among the plurality of conductive patterns on a straight line along the predetermined direction is 0.5 mm or greater and 1.5 mm or less.

### TECHNICAL FIELD

The present invention relates to reflectors, and more particularly to reflectors having a meta surface.

### BACKGROUND ART

When high-frequency radio waves such as microwaves, millimeter waves, and terahertz waves are used in wireless communication, it is possible perform high-speed and large-capacity communication. On the other hand, high-frequency radio waves of 1 GHz to 10 THz have strong directivity, and there is a drawback in that the communication may fail if obstacles exist between a transmitting antenna and a receiving antenna, preventing the radio waves from reaching the receiving antenna. A reflector is used to improve a communication environment and a communication area of mobile communication using the high frequency. Because a standard reflector has a specular reflection surface where an angle of incidence equals an angle of reflection, a reflection range is limited. In order to extend a communication range, metareflectors having metasurfaces that reflect incident waves in desired directions are actively being developed.

The “metasurface” refers to an artificial surface designed to control transmission properties and reflection properties of incident electromagnetic waves. Metal patterns may be arranged cyclically at approximately half-wavelength intervals, and the reflection properties may be controlled to reflect incident waves in a desired direction. There is a proposed reflect array in which array elements are formed in divided regions on a substrate, and gaps between multiple patches constituting the array elements are varied for each region (for example, refer to Patent Document 1).

### PRIOR ART DOCUMENTS

### Patent Documents

Patent Document 1: Japanese Patent No. 5177708

### DISCLOSURE OF THE INVENTION

### Problem to be Solved by the Invention

Because the reflectarray having the metasurface utilizes resonance phenomena, in a case where the waves are to be reflected in the desired direction (hereinafter, also referred to as “a target direction”) at a predetermined frequency, a reflection distance to a target and a beam diameter are in an inversely proportional relationship, and thus, there is a problem that the beam diameter of a main lobe of the reflected waves in the target direction becomes narrower as the reflection distance becomes longer. When the beam diameter of the main lobe becomes narrower, a coverage range in a space within a radio wave propagation distance becomes limited, and the communication may fail.

In one aspect, one object of the present invention is to provide a reflector in which a beam diameter of a main lobe of reflected waves in a target direction is increased.

### Means of solving the Problem

In one embodiment, a reflector includes a dielectric layer; a conductive layer formed on a first surface of the dielectric layer and including a plurality of conductive patterns that reflect incident waves; and a ground layer formed on a second surface of the dielectric layer opposite to the first surface, wherein the plurality of the conductive patterns is disposed along a predetermined direction, and a standard deviations σ of a difference between an ideal distance and a center-to-center distances between centers of a reference conductive pattern and an arbitrary conductive pattern among the plurality of conductive patterns on a straight line along the predetermined direction is 0.5 mm or greater and 1.5 mm or less.

### Effects of the Invention

According to the configuration described above, it is possible to provide a reflector in which the beam diameter of the main lobe of the reflected waves in the target direction is increased.

### BRIEF DESCRIPTION OF THE DRAWINGS

FIG. 1 is a diagram illustrating a basic configuration of a reflector according to a first embodiment.

FIG. 2 is a diagram illustrating an example of a method of designing a conductive pattern.

FIG. 3A is a diagram illustrating a design example of the reflector according to the first embodiment.

FIG. 3B is a diagram illustrating the design example of the reflector according to the first embodiment.

FIG. 4 is a diagram illustrating reflection properties of the reflector according to the design of FIG. 3A and FIG. 3B.

FIG. 5 is a diagram illustrating configurations of standard deviations in exemplary implementations and comparative examples.

FIG. 6 is a diagram illustrating the reflection properties of the reflector according to the design of FIG. 5.

FIG. 7 is a diagram illustrating the reflection properties of the reflector according to the design of FIG. 5.

FIG. 8A is a diagram illustrating the reflection properties of a low permittivity reflector.

FIG. 8B is a diagram illustrating the reflection properties of the low permittivity reflector.

FIG. 8C is a diagram illustrating the reflection properties of the low permittivity reflector.

FIG. 9A is a diagram illustrating the reflection properties of a high permittivity reflector.

FIG. 9B is a diagram illustrating the reflection properties of the high permittivity reflector.

FIG. 9C is a diagram illustrating the reflection properties of the high permittivity reflector.

FIG. 10A is a diagram illustrating a reflection range of the low permittivity reflector with respect to frequency.

FIG. 10B is a diagram illustrating the reflection range of the high permittivity reflector with respect to frequency.

FIG. 11 is a diagram illustrating a relationship between thicknesses of dielectric layers having different permittivities and a reflection bandwidth.

FIG. 12 is a diagram illustrating a relationship between the thicknesses of the dielectric layers having the different permittivities and a reflection intensity.

FIG. 13 is a diagram illustrating configurations and properties of the exemplary implementations and the comparative examples.

FIG. 14 is a schematic diagram of the reflector according to a second embodiment.

FIG. 15 is a diagram illustrating results of simulations in which a thickness and a permittivity of a protective layer are varied.

FIG. 16A is a diagram illustrating an example of use of the reflector according to an embodiment.

FIG. 16B is a diagram illustrating an example of use of a standard reflector.

### MODE OF CARRYING OUT THE INVENTION

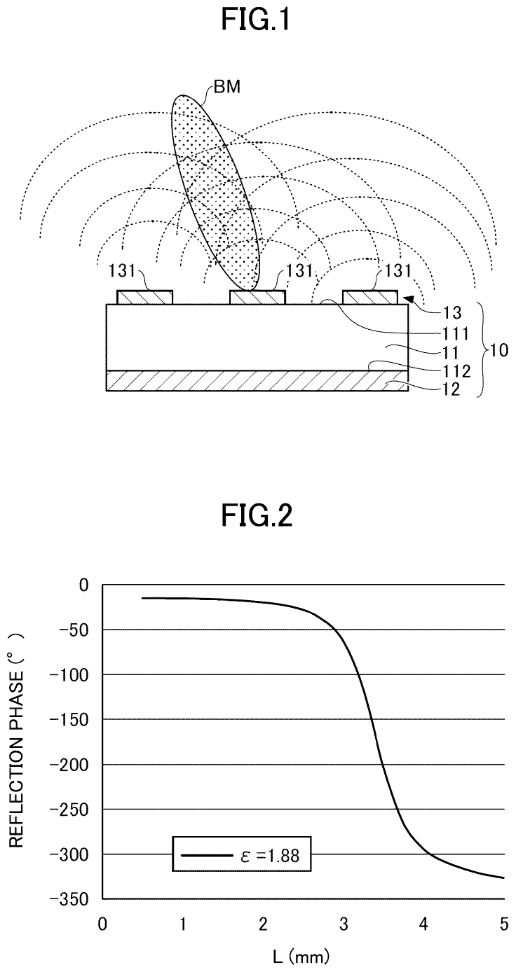

FIG. 1 is a diagram illustrating a basic configuration of a reflector 10 according to a first embodiment. The reflector 10 includes a dielectric layer 11, a conductive layer 13 provided on a first surface 111 of the dielectric layer 11, and a ground layer 12 provided on a second surface 112 of the dielectric layer 11 opposite to the first surface 111. The conductive layer 13 includes an array of a plurality of conductive patterns 131, and functions as a reflection surface of the reflector 10. The reflection surface is a metasurface that reflects incident waves at an angle (absolute value) different from an angle of incidence. The ground layer 12 enables a capacitance to be formed between the ground layer 12 and each conductive pattern 131, and an amount of phase delay can be controlled for each conductive pattern 131. Materials used for the conductive layer 13 and the ground layer 12 are not particularly limited as long as the materials are electrically conductive, but for example, copper foil is preferable from viewpoints of electrical conductivity, manufacturability, workability, material cost, or the like.

Size and pitch of the conductive patterns 131 are set according to required reflection properties. Each conductive pattern 131 has a size sufficiently smaller than a wavelength used, and selectively reflects radio waves of a target frequency bandwidth. A reflection phase is controlled by the conductive patterns 131, and the reflected waves are superimposed to form a reflected beam BM in a desired direction.

A wavelength of the incident radio waves is denoted by A, the pitch of the conductive patterns 131, that is, a distance between centers of the adjacent conductive patterns 131 is denoted by d, the phases of the radio waves reflected by the two adjacent conductive patterns 131 are denoted by δ1 and δ2, respectively, and an angle of reflection is denoted by θ. A phase difference δ1−δ2 can be expressed by a formula (1).

$$δ1 - δ2 = ( 2 π / λ ) d + sin θ + 2 n π \qquad ( 1 )$$

Where n is an integer.

In order to reflect the radio waves in a desired direction by the reflector 10, δ1, δ2, and d may be designed so that a desired angle of reflection, θ can be obtained. The angle of reflection, θ is set to a desired angle between a normal direction (0°) and a horizontal direction (90°) with respect to a reflection surface of the reflector 10, excluding 0° and 90°.

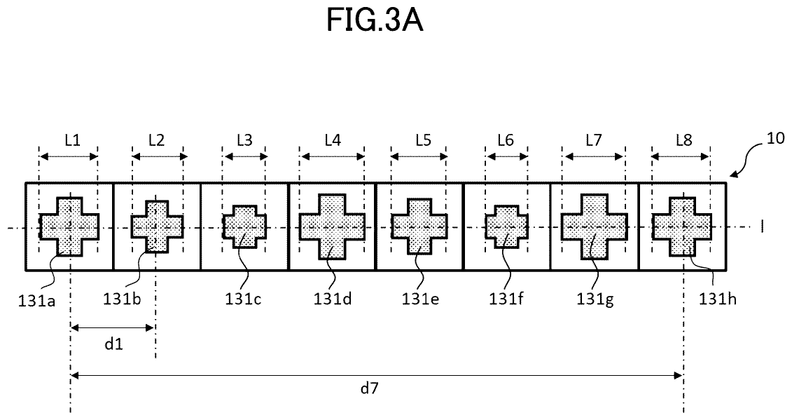

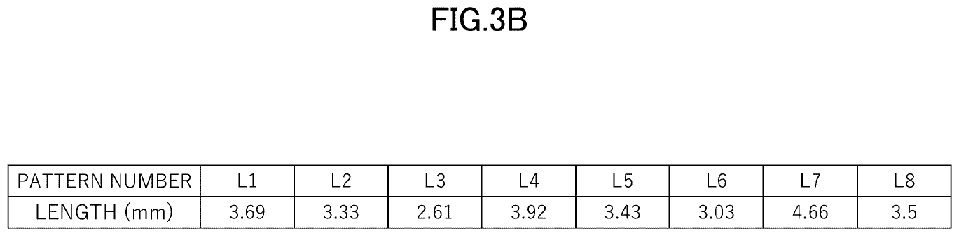

Values of δ1 and δ2 representing the reflection phase can be controlled and varied by design parameters, such as the wavelength λ of the incident radio waves, the size (length×width) and pitch of the conductive patterns 131, and a thickness and a relative permittivity of the reflector 10. For example, in a case of designing a length L of the conductive pattern 131 that provides the desired phase difference, the conductive pattern 131 may be designed by creating a graph of the length/phase characteristics illustrated in FIG. 2. The length/phase characteristics of FIG. 2 can be obtained by measuring a reflection pattern of radio waves while varying the length L of the conductive pattern in a state where design parameters other than the length L (mm) are fixed, and analyzing the reflection pattern using three-dimensional electromagnetic field simulation software. The length L is the length of the conductive pattern 131 corresponding to an oscillation direction of the radio waves, and as illustrated in FIG. 3A, in a case where the conductive patterns 131a through 131g are cross patterns, vertical and horizontal lengths of each conductive pattern are equal. As a design parameter other than the length, a relative permittivity & of the dielectric layer 11 is fixed to ϵ=1.88, for example.

(Distance between Centers)

In the conductive layer 13, the plurality of conductive patterns 131 having different sizes is arranged at predetermined intervals. As illustrated in FIG. 3A, in the reflector 10 according to the first embodiment, the conductive patterns 131 are arranged in a line on a straight line l. Center points of the conductive patterns 131 are located on an arbitrary straight line. The conductive patterns 131 do not need to be arranged linearly, and may be arranged in a staggered pattern or in other arrangement patterns in the direction of arrangement.

In the present specification, the “center point of the conductive pattern” refers to a center point of a circle inscribed within a contour of each conductive pattern in the plan view of the conductive pattern. In addition, a distance between the center points of a reference conductive pattern and an arbitrary conductive pattern is referred to as “a center-to-center distance”. Moreover, for the sake of convenience in a case where a plurality of conductive patterns are arranged, a distance between center points of the reference conductive pattern and an m-th conductive pattern counted from the reference conductive pattern may be denoted as “dm” or “dm′” using an arbitrary integer m which is 1 or greater. For example, a first conductive pattern 131a from the left in FIG. 3A is regarded as the reference conductive pattern, a center-to-center distance between the reference conductive pattern and a first conductive pattern counted from the reference conductive pattern in the direction of arrangement (a second conductive pattern 131b from the left in FIG. 3A) is denoted by an ideal distance dl and an actual distance d1′ which will be described later, respectively, and a center-to-center distance between the reference conductive pattern and a seventh conductive pattern (an eighth conductive pattern 131h from the left in FIG. 3A) is denoted by an ideal distance d7 and an actual distance d7′, respectively.

### (Ideal Distance)

When designing the plurality of conductive patterns 131 to be arranged as the conductive layer 13, in a case where in-phase incident waves are incident on the reference conductive pattern and an m-th conductive pattern counted from the reference conductive pattern among the plurality of conductive patterns 131, the center-to-center distance between the reference conductive pattern at which the intensity of the reflected wave is the highest and the m-th conductive pattern is defined as “an ideal distance” of the m-th conductive pattern. In the present specification, the ideal distance is denoted by dm. By arranging the conductive patterns 131 of the conductive layer 13 at the ideal distance dm, a reflector having a long propagation distance of the reflected waves can be obtained. The ideal distance dm is preferably 0.5 λ or greater and 0.7 λ or less with respect to the wavelength λ of the incident waves from a viewpoint of robustness when designing the reflection properties of the reflector.

### (Actual Distance)

With respect to the ideal distance dm, the center-to-center distance between the first conductive pattern and the m-th conductive pattern formed on the first surface of the dielectric layer is defined as “an actual distance” of the m-th conductive pattern. In the present specification, the actual distance is denoted by dm′.

### (Increase in Beam Diameter)

In the reflector according to the first embodiment of the present invention, when
an absolute value of a difference between the actual distance dm′ and the ideal distance dm is defined as |dm′−dm|, and
m is an integer which is 1 or greater,
a standard deviation σ of a group of |dm′−dm| of the conductive patterns other than the reference conductive pattern is 0.5 mm or greater and 1.5 mm or less. As a result of diligent studies, the present inventors found that, by designing the reflector in this manner, when the radio waves are incident on the reflector at an arbitrary phase, the beam diameter of the main lobe of the reflected waves increases. In the present specification, the “beam diameter” is defined as a reflection angle range in which a difference Δ of intensities with respect to a peak intensity becomes 10 dB when a graph is formed with an abscissa indicating the angle of reflection and an ordinate indicating the reflected wave intensity in an intensity distribution of the main lobe of the reflected waves.

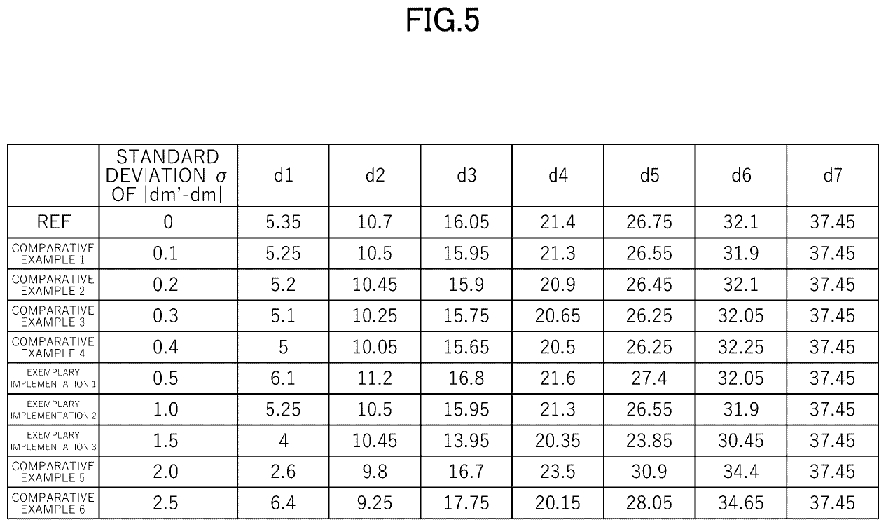

In a second embodiment of the present invention, the reflector has the same configuration as that of the first embodiment, and further, the dielectric layer 11 has a relative permittivity of 2.0 or less. By setting the relative permittivity to 2.0 or less, it is possible to expand a frequency band of the radio waves reflected in a predetermined direction. Details of the expansion of the reflection frequency bandwidth of the reflected radio waves will be described later with reference to FIG. 5 and subsequent drawings. Fluoropolymers such as polytetrafluoroethylene or the like, bonded structures of fluoropolymer and inorganic porous aggregate, other transparent porous resins, or the like can be used as the dielectric material having the relative permittivity of 2.0 or less. Polytetrafluoroethylene, polystyrene, or the like is used as the resin to be bonded to the inorganic porous aggregate.

The inorganic porous aggregate is prepared by a method proposed in Japanese Laid-Open Patent Publication No. 2017-171898, for example. The porosity of the bonded structure can be controlled to 50% or greater by adjusting a material, an aggregation density, or the like of a porous inorganic nanoparticles. By adjusting the porosity to control the relative permittivity, the permittivity of 2.0 or less can be obtained.

FIG. 3A and FIG. 3B illustrate design examples of the reflector 10 according to the first embodiment.

FIG. 3A illustrates the arrangement of the conductive patterns 131a through 131h constituting the conductive layer 13. FIG. 3B illustrates the size of each conductive pattern. The conductive patterns 131a through 131h are cross patterns having the same vertical and horizontal lengths. The size of each conductive pattern 131 is indicated by the vertical or horizontal lengths L1 through L8. The incident waves in a 28 GHz band has a wavelength λ=10.8 mm, and the pitch of the conductive patterns 131a through 131h, that is, the ideal distance dm of the center-to-center distance is 5.35 mm for each conductive pattern 131.

An angle of reflection of −42° is targeted by the arrangement of the conductive patterns 131a through 131h. The angle of reflection in this case is an angle of reflection in a case where the radio waves are incident perpendicularly with respect to the reflector 10, that is, an angle of reflection with respect to a normal. When |δ1−δ2|, which is the phase difference when θ is −42°, is obtained based on the formula (1) described above, the phase difference of 120° is obtained. The sizes of the conductive patterns 131a through 131h, that is, the lengths L1 through L8, are determined so that this phase difference can be obtained.

The shape of the conductive pattern 131 is not limited to the cross pattern, and a circular shape, an elliptical shape, a polygonal shape, or the like of different sizes may be provided at predetermined cycles. The size of the conductive pattern 131 is preferably a length of 2.0 mm to 5.0 mm in the case where the 28 GHz band is targeted, but the size of the conductive pattern 131 can be appropriately designed according to the frequency bandwidth. Radio waves having the frequency determined by the size and the cycle of the conductive pattern 131 are selectively reflected. Generally, the frequency band selected by resonance is narrow, but by setting the relative permittivity of the dielectric layer 11 to 2.0 or less, the selected frequency band can be expanded to a bandwidth of 4 GHz or greater, more preferably to a bandwidth of 6 GHz or greater. Because the selected frequency bandwidth may vary depending on a thickness of the dielectric layer 11 of the reflector 10, a broadband reflector having a bandwidth per unit thickness (1 mm) of the reflector 10 exceeding 6.5 GHz/mm is to be obtained.

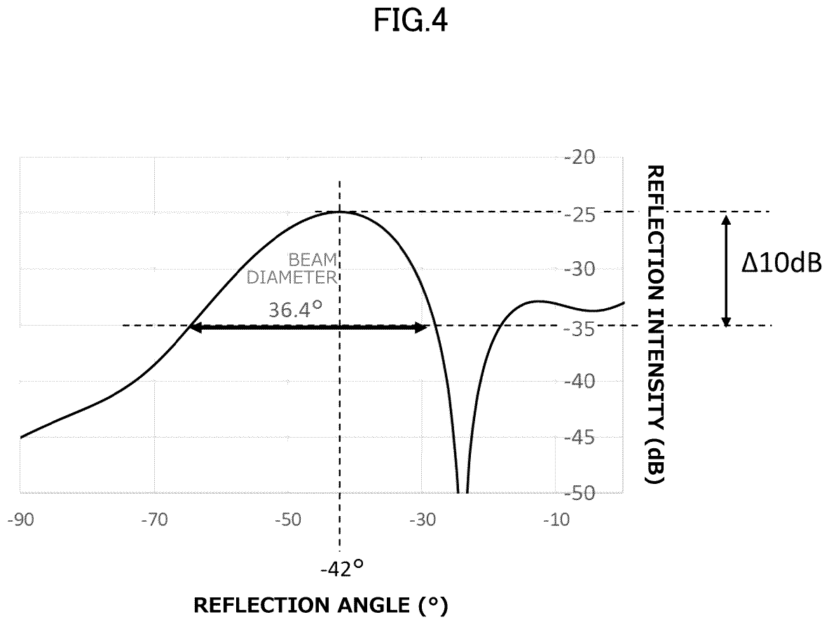

FIG. 4 illustrates the reflection properties of the reflector 10 with respect to Ref, which is designed so that a standard deviation σ of the absolute value |dm′−dm| of the difference between the actual distance dm′ and the ideal distance dm becomes 0 when designing the conductive patterns of FIG. 3A and FIG. 3B. The abscissa indicates the angle of reflection, and the ordinate indicates the reflection intensity (dB). A main peak is observed in the −42° direction, and it can be confirmed that the reflector 10 can control a reflection direction of the radio waves substantially as designed. In addition, the beam diameter of the main lobe at −42°, that is, the reflection angle range that decreases by 10 dB from the peak, is 36.4°.

<Enlargement of Beam Diameter by Standard Deviation σ>

With respect to the standard deviation σ of the absolute value |dm′−dm| of the difference between the actual distance dm′ and the ideal distance dm, the actual distance was varied from d1 to d7 as illustrated in FIG. 5 and designed so that σ becomes σ=0, 0.1, 0.2, 0.3, 0.4, 0.5, 1.0, 1.5, 2.0, and 2.5 for exemplary implementations 1 through 3 and comparative examples 1 through 6, and a reflectance spectrum with respect to incident 28 GHz plane waves was calculated using the dielectric layer 11 having the relative permittivity & of 1.88. The reflection intensity was analyzed for each angle, using CST Studio Suite manufactured by Dassault Systèmes SE, which is general-purpose three-dimensional electromagnetic field simulation software. The angle at which the peak of the reflection intensity appears is defined as “a reflection peak angle”.

The reflection peak angle and the beam diameter were evaluated as follows.

σ: The beam diameter is larger than that of REF, and the difference in reflection peak angle is within ±2° with respect to the reflection peak angle of REF.
Δ: The beam diameter is larger than that of REF, but the reflection peak angle deviates.
x: The beam diameter is smaller than that of REF.

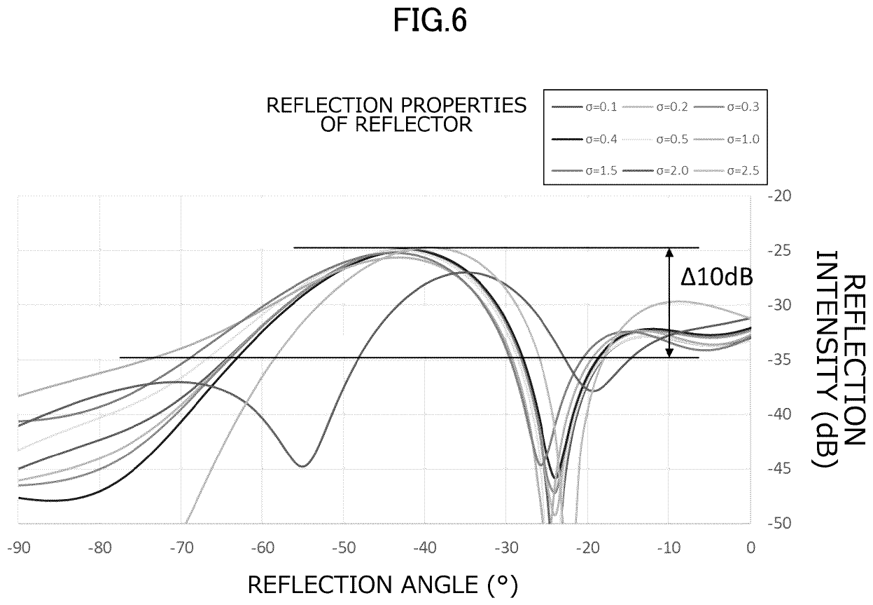

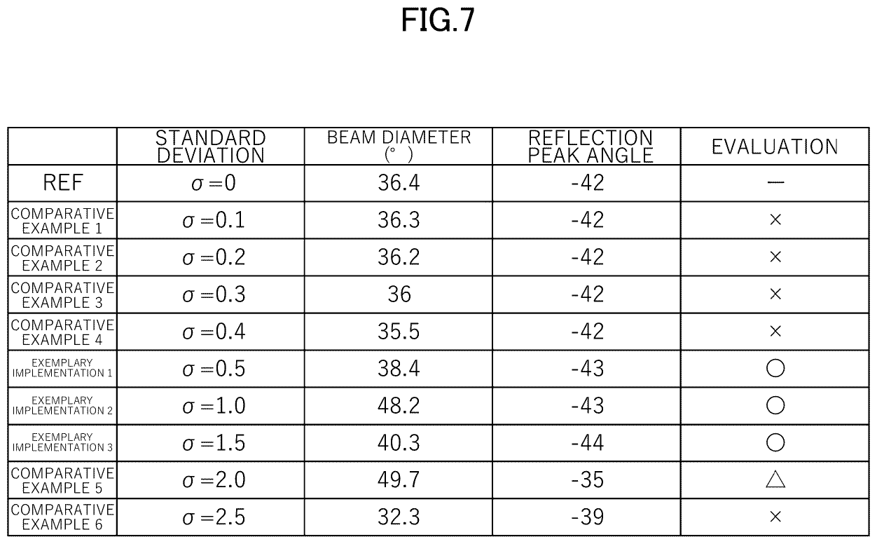

The simulation results of the reflection properties of the reflector having the design of FIG. 5 are illustrated in FIG. 6 and FIG. 7. In FIG. 6, the ordinate indicates the reflection intensity (unit: dB), and the abscissa indicates the angle of reflection (unit: °).

As illustrated in FIG. 6 and FIG. 7, it can be observed that the beam diameters of the exemplary implementations 1 through 3 and the comparative examples 5 and 6 in which the standard deviation σ is 0.5 mm or greater are larger than that of REF. On the other hand, it was found that in the comparative examples 5 and 6 in which the standard deviation σ is 2.0 or greater, a deviation of the reflection peak angle was 3° or more with respect to the design value, and thus, the desired reflection properties were not obtainable. Further, it was found that the beam diameters of the comparative examples 1 through 4 in which the standard deviation o is less than 0.5 mm were smaller than that of REF. From the above, it was found that when the standard deviation σ is 0.5 mm or more and 1.5 mm or less, the desired angle of reflection can be maintained while increasing the beam diameter.

### (More Preferable Configuration)

### <Expansion of Reflection Frequency Band by Reduced Permittivity>

By using a material having a low relative permittivity for the dielectric layer 11 of the reflector 10, it is possible to expand the reflection frequency bandwidth. The reflection frequency bandwidth refers to a frequency range in which a 3 dB attenuation occurs from the peak intensity of the main lobe of the reflected waves in the target direction with respect to the incident waves of the used wavelength. Hereinafter, the target value of the reflection peak angle is modified by design to “35°”, and analysis and evaluation were performed by simulation.

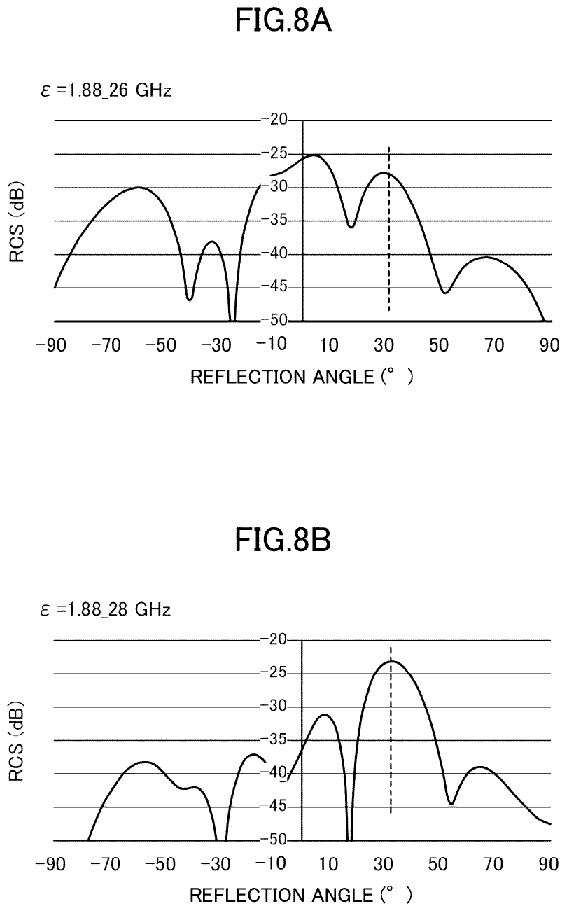

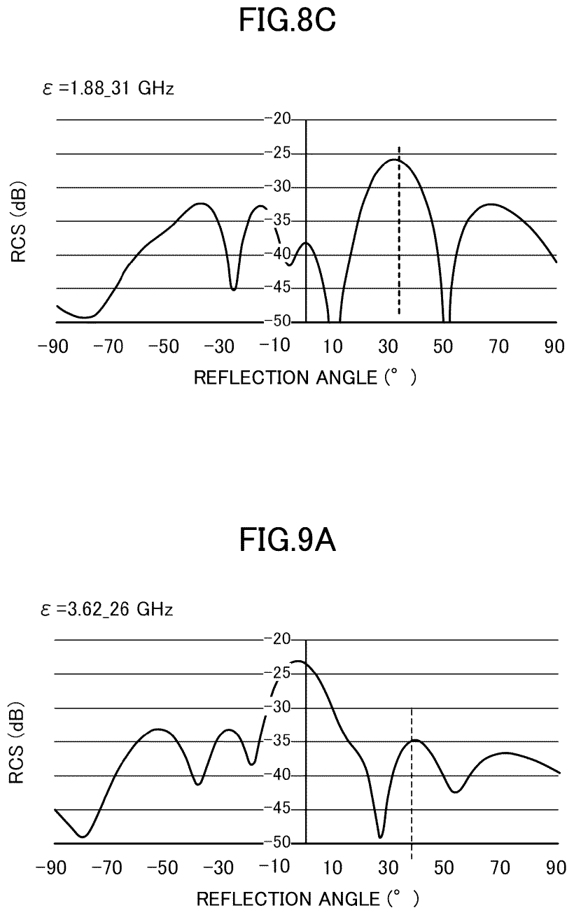

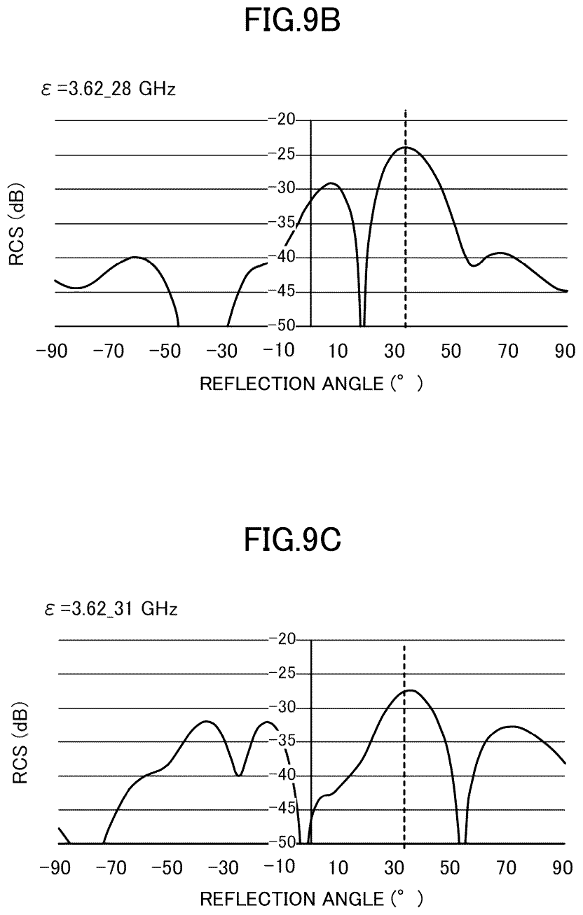

FIG. 8A through FIG. 8C illustrate the reflection properties of a low permittivity reflector for incident waves of different frequencies. The low permittivity reflector refers to a reflector according to the embodiment, and is the reflector 10 using the dielectric layer 11 having the relative permittivity of 2.0 or less. In this example, a dielectric layer having a relative permittivity s of 1.88 is used. For the purpose of comparison, FIG. 9A through FIG. 9C illustrate the reflection properties of a high permittivity reflector for incident waves of different frequencies. The high permittivity reflector refers to a reflector using a dielectric layer having a relative permittivity of more than 2.0.

In FIG. 8A through FIG. 8C, reflection spectra at 26 GHz, 28 GHz, and 31 GHz are calculated using the dielectric layer 11 having the relative permittivity s of 1.88. The reflection intensity on the ordinate is indicated by a radar cross section (RCS) which is an index indicating the reflective capability. Plane waves in the 26 GHz, 28 GHz, and 31 GHz frequency bands are incident from the normal direction with respect to the reflector, and the scattering cross section is analyzed for each angle using the CST Studio Suite manufactured by Dassault Systèmes SE, which is the general-purpose three-dimensional electromagnetic simulation software.

When ϵ=1.88, the peak of the reflectance spectrum appears in the 35° direction at each of 26 GHz, 28 GHz, and 31 GHz. In each of these frequency bandwidths, the peak value falls within a range of −25 dB±2.5 dB, and a stable peak intensity can be obtained at the target angle of reflection of 35° across at least a 5 GHz frequency band.

In particular, at 28 GHz and 31 GHz, the main lobe at the angle of reflection of 35° is clearly distinguishable from the other side lobes, and it can be observed that the incident waves are reflected in the target 35° direction with a good controllability. At 26 GHz, other peaks appear at 0° and −65° in addition to the peak at 35°. The peak at 0° is a reflection in the same direction as the direction of incidence, and corresponds to a loss. The peak at −65° is a reflection in a direction opposite to the target 35° direction, and may become a loss or may become an advantage of simultaneously delivering radio waves in two directions, depending on an environment in which the reflector is used.

In the comparative examples of FIG. 9A through FIG. 9C, the relative permittivity s is varied to 3.62, and other conditions such as the conductive pattern are maintained the same as those of the reflector of FIG. 8A through FIG. 8C. Examples of the material having a relative permittivity of 3.62 include polyphenylene ether (PPE), acrylic resin, or the like. For the relative permittivity of 3.62, the reflection peak appears in the target 35° direction at 28 GHz and 31 GHz, but a degradation of the spectral shape of the main lobe at 31 GHz occurs. At 26 GHz, a reflection is not obtained in the target 35° direction.

The configuration in FIG. 9A through FIG. 9C directly reflects the fact that a degradation of the reflection properties of metasurface that uses resonance occurs when the frequency varies. By using the low permittivity reflector according to the embodiment illustrated in FIG. 8A through FIG. 8C, the frequency characteristics are greatly improved. Based on FIG. 8A through FIG. 8C and FIG. 9A through FIG. 9C, it can be observed that the reflection frequency bandwidth can be expanded by decreasing the permittivity of the dielectric layer 11 used for the reflector 10 to a certain extent.

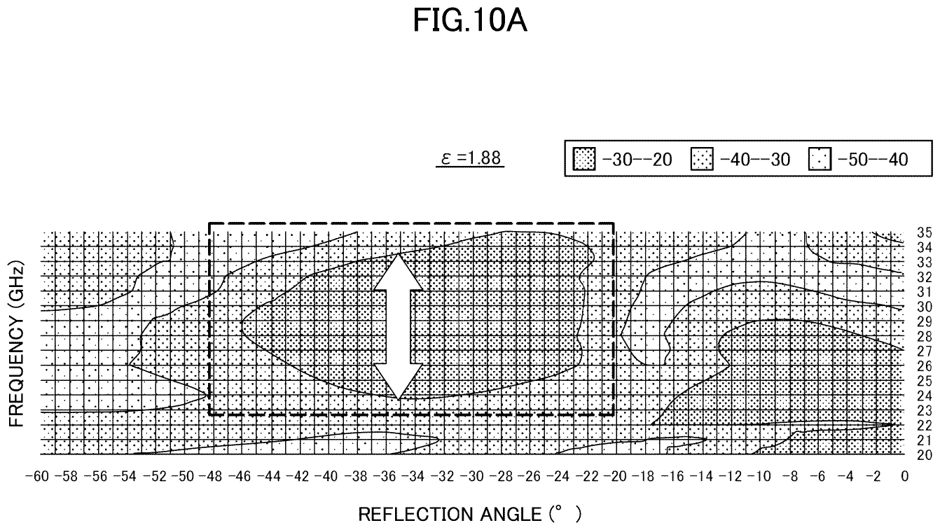

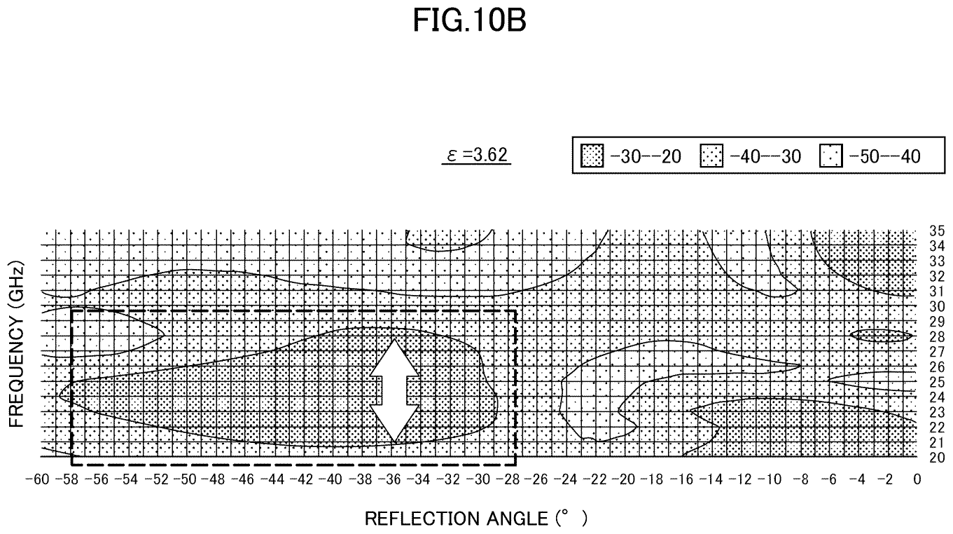

FIG. 10A illustrates a reflection range of a low permittivity reflector, and FIG. 10B illustrates a reflection range of a high permittivity reflector. In FIG. 10A and FIG. 10B, the abscissa indicates the angle of reflection, and the ordinate indicates the frequency of the incident waves. A reflector model used has a conductive pattern identical to that illustrated in FIG. 3A formed on the surface of the dielectric layer. The relative permittivity & of the low permittivity reflector of FIG. 10A is set to 1.88, and the relative permittivity s of the high permittivity reflector of FIG. 10B is set to 3.62.

In FIG. 10A, a high reflection intensity (exceeding −30 dB and −20 dB or less) is obtained from 24 GHz to 33 GHz in the target 35° direction. The reflection intensity is distributed in a range of ±10° centered around 35°, and particularly, the reflection intensity exceeding −30 dB and −20 dB or less is obtained over a frequency band of 10 GHz or greater in a range of 23° or greater and 35° or less. The wide range of reflection frequency characteristics provides a high resistance to environmental changes.

In FIG. 10B, when the relative permittivity is 3.62, a high reflection intensity (exceeding 30 dB and −20 dB or less) is obtained from 21 GHz to 28.5 GHz in the target 35° direction. However, considering the frequency bands actually used in various countries, a practical frequency band for the reflector of FIG. 10B is in a range from 24 GHz to 28.5 GHz. Considering the frequency bands used in the various countries and the possibility of a peak shift, a reflector having a frequency band of 24 GHz or greater and 60 GHz or less and a frequency bandwidth of 6 GHz is desired.

From FIG. 10A and FIG. 10B, it can be observed that the lower the permittivity of the dielectric layer 11 of the reflector, the wider the reflection range (angular range) with respect to the frequency and the wider the practical frequency band of the reflection.

### <Thickness of Dielectric Layer>

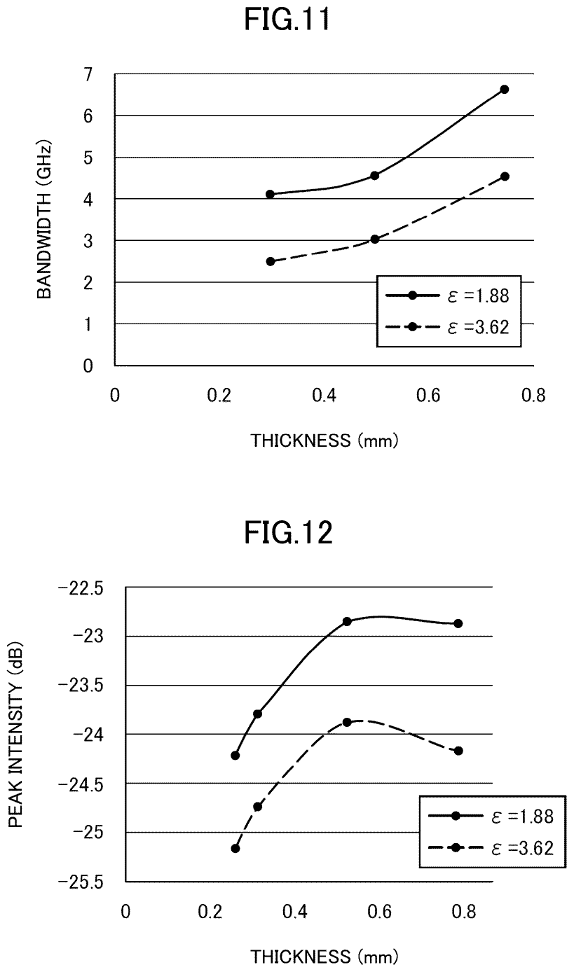

The thickness of the dielectric layer 11 will be discussed with reference to FIG. 11 and FIG. 12. FIG. 11 illustrates a relationship between the thickness of dielectric layers having different permittivities and the reflection frequency bandwidth. FIG. 12 illustrates a relationship between the thickness of the dielectric layer having different permittivities and the reflection intensity. In FIG. 11, the thickness of the dielectric layer 11 is varied to 0.30 mm, 0.50 mm, and 0.75 mm. The conductive patterns 131 formed on the first surface 111 of the dielectric layer 11 are the same as those illustrated in FIG. 3A. The configuration of the conductive patterns is the same, but the relative permittivity & of the dielectric layer 11 is varied. 28 GHz plane waves are incident from the normal direction with respect to the reflector, and the reflection frequency bandwidth is analyzed. As described above, the bandwidth of the reflected waves is a frequency range in which a 3 dB attenuation occurs from the peak intensity of the main lobe of the reflected waves.

In a case where the thickness of the dielectric layer 11 is the same, the lower the relative permittivity ϵ, the wider the reflection frequency bandwidth. Conversely, when achieving the same reflection frequency bandwidth, a material having a low permittivity enables the reflector to be formed thinner. In the example illustrated in FIG. 11, when the thickness of the dielectric layer 11 is 0.75 mm, a reflector with ϵ of 1.88 achieves a reflection frequency bandwidth exceeding 6.5 GHz, whereas a reflector with ϵ of 3.62 can only cover a reflection frequency bandwidth of 4.5 GHz.

As described above, considering the frequency bands and the peak shift used in various countries, it is desirable that the reflection frequency bandwidth exceeds 6 GHz in the frequency range of 24 GHz or greater and 30 GHz or less. By interpolating data points in FIG. 11, the reflection frequency bandwidth of 6 GHz may be achieved by increasing the thickness of the dielectric layer 11 with ϵ of 3.62 to approximately 1.2 mm. However, in this case, the reflector becomes thick, a degradation of flexibility occurs, and an application range becomes limited.

On the other hand, in the case of the dielectric layer with ϵ of 1.88, a reflection frequency bandwidth of 6.5 GHz can be achieved by the dielectric layer 11 having a thickness of 0.75 mm, and a flexible sheet reflector can be obtained. The sheet reflector is easy to handle, and can be attached to a desired location like wallpaper. It is a great advantage that a wider bandwidth can be achieved by the thin and flexible dielectric layer 11.

In FIG. 12, the peak intensity of the reflected waves is calculated by varying the thickness of the dielectric layer 11 to 0.25 mm, 0.30 mm, 0.50 mm, and 0.80 mm. When the relative permittivity ϵ is 1.88, a peak intensity exceeding −24 dB can be obtained by setting the thickness of the dielectric layer 11 to 0.30 mm or greater. When ϵ is 3.62, a peak intensity of the same level cannot be obtained unless the thickness of the dielectric layer 11 is set to 0.5 mm.

From the results of FIG. 12, the low permittivity reflector according to the embodiment is advantageous also from a viewpoint of reducing the thickness and weight of the device.

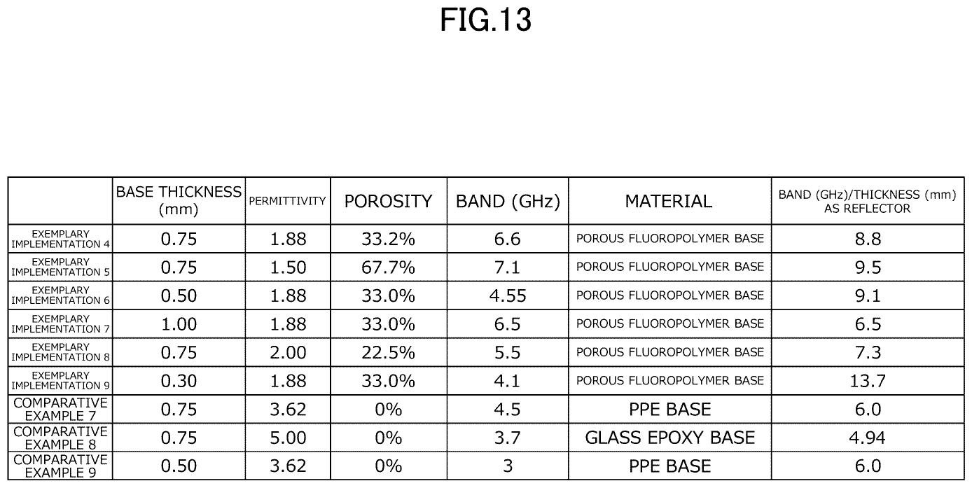

FIG. 13 illustrates the configurations and properties of the exemplary implementations and comparative examples. Structural parameters include the type, thickness, relative permittivity, and porosity of a base material constituting the dielectric layer 11. Values of these parameters are varied. As the properties of the reflector, the reflection frequency bandwidth and a bandwidth per unit thickness are illustrated. In the exemplary implementations and the comparative examples, the conductive patterns 131 include the conductive patterns 131a through 131h illustrated in FIG. 3A, and the type and the parameters of the dielectric layer 11 are varied.

A simulation was performed under the following conditions, and the reflection frequency bandwidths of the exemplary implementations and the comparative examples were obtained from a far-field radiation region, an intensity, and an angle of the reflectance spectrum with respect to the incident waves.

Wavelength of incident waves: 10.7 mm (frequency of 28 GHz)

Frequency variation range of incident waves: from 20 GHz to 35 GHz

Incident angle of incident waves with respect to normal direction of reflector: 0 degree

First desired angle of reflection, θ of the reflectance spectrum with respect to the normal direction of the reflector: 35 degrees Number of conductive patterns: 8 (series arrangement)

Pitch of conductive patterns: 5.35 mm

Standard deviation σ: 0.5 mm (designed with the same pitch as in the exemplary implementation 1)

### Exemplary Implementation 4

In an exemplary implementation 4, a fluorine porous substrate is used as the base material of the dielectric layer 11. The fluorine porous substrate is a bonded structure of a fluoropolymer and an inorganic porous aggregate. Polytetrafluoroethylene is used as the fluoropolymer. The dielectric substrate has a thickness of 0.75 mm, a porosity of 33.2%, and a relative permittivity of 1.88. The reflection frequency bandwidth of the reflector obtained in the exemplary implementation 1 is 6.6 GHz, and the bandwidth per unit thickness (1 mm) is 8.8 GHz/mm.

### Exemplary Implementation 5

In an exemplary implementation 5, a fluorine porous substrate is used as the base material of the dielectric layer 11. The dielectric substrate has a thickness of 0.75 mm, a porosity of 67.7%, and a relative permittivity of 1.50. The dielectric layer 11 is designed to have different porosities and relative permittivities by varying the aggregation density of the porous inorganic nanoparticles used for the fluorine porous substrate. The reflection frequency bandwidth of the reflector obtained in the exemplary implementation 5 is 7.1 GHz, and the bandwidth per unit thickness (1 mm) is 9.5 GHz/mm.

### Exemplary Implementation 6

In an exemplary implementation 6, a fluorine porous substrate is used as the base material of the dielectric layer 11. The dielectric substrate has a thickness of 0.50 mm, a porosity of 33.0%, and a relative permittivity of 1.88. The dielectric layer 11 is designed to have different porosities and relative permittivities by varying the aggregation density of the porous inorganic nanoparticles used for the fluorine porous substrate. The dielectric layer 11 is made thinner than those of the exemplary implementations 4 and 5. The reflection frequency bandwidth of the reflector obtained in the exemplary implementation 6 is 4.55 GHz, and the bandwidth per unit thickness (1 mm) is 9.1 GHz/mm.

### Exemplary Implementation 7

In an exemplary implementation 7, a fluorine porous substrate is used as the base material of the dielectric layer 11. The dielectric substrate has a thickness of 1.00 mm, a porosity of 33.0%, and a relative permittivity of 1.88. The dielectric layer 11 is made thicker than those of the exemplary implementations 4 and 5. The reflection frequency bandwidth of the reflector obtained in the exemplary implementation 7 is 6.5 GHz, and the bandwidth per unit thickness (1 mm) is 6.5 GHz/mm.

### Exemplary Implementation 8

In an exemplary implementation 8, a fluorine porous substrate is used as the base material of the dielectric layer 11. The dielectric substrate has a thickness of 0.75 mm, a porosity of 22.5%, and a relative permittivity of 2.00. The dielectric layer is designed to have different porosities and relative permittivities by varying the aggregation density of the porous inorganic nanoparticles used for the fluorine porous substrate. The reflection frequency bandwidth of the reflector obtained in the exemplary implementation 8 is 5.5 GHz, and the bandwidth per unit thickness (1 mm) is 7.3 GHz/mm.

### Exemplary Implementation 9

In an exemplary implementation 9, a fluorine porous substrate is used as the base material of the dielectric layer 11. The dielectric substrate has a thickness of 0.3 mm, a porosity of 33.0%, and a relative permittivity of 1.88. The dielectric layer 11 is made thinner than that of the exemplary implementation 8. The reflection frequency bandwidth of the reflector obtained in the exemplary implementation 9 is 4.1 GHz, and the bandwidth per unit thickness (1 mm) is 13.7 GHz.

### Comparative Example 7

In a comparative example 7, a PPE substrate is used as the base material of the dielectric layer 11.

The PPE substrate has a thickness of 0.75 mm, a porosity of 0.0%, and a permittivity of 3.62. The reflection frequency bandwidth of the reflector obtained in the comparative example 7 is 4.5 GHz, and the bandwidth per unit thickness (1 mm) is 6.0 GHz/mm. Although the substrate having the same thickness is used, the relative permittivity is high, and thus, the reflection frequency bandwidth is narrow, compared to the exemplary implementations 4, 5, and 8.

### Comparative Example 8

In a comparative example 8, a glass epoxy substrate is used as the base material of the dielectric layer 11. The dielectric substrate has a thickness of 0.75 mm, a porosity of 0.0%, and a relative permittivity of 5.00. The relative permittivity is even higher than that of the comparative example 7. The reflection frequency bandwidth the reflector obtained in the comparative example 8 is 3.7 GHz, and the bandwidth per unit thickness (1 mm) is 4.9 GHz/mm.

### Comparative Example 9

In a comparative example 9, a PPE substrate is used as the base material of the dielectric layer 11.

The dielectric substrate has a thickness of 0.50 mm, a porosity of 0.0%, and a relative permittivity of 3.62. The reflection frequency bandwidth of the reflector obtained in the comparative example 9 is 3.0 GHz, and the bandwidth per unit thickness (1 mm) is 6.0 GHz. The PPE substrate used is the same as that used in the comparative example 7, but the thickness of the substrate is reduced, so that the reflection frequency bandwidth is further narrowed.

From the results of FIG. 13, it can be observed that when the relative permittivity of the dielectric layer 11 is 2.0 or less, a broadband reflective characteristic exceeding 6.5 GHz, preferably exceeding 7.0 GHz, and more preferably exceeding 8.0 GHz per unit thickness of the reflector is obtainable. When the dielectric layer is thin and the relative permittivity is 1.88 or less, a frequency band of 8.8 GHz or greater per unit thickness of the reflector can be achieved. In the exemplary implementations 8 and 9, by using a material having a low relative permittivity for the fluoropolymer to be combined with the inorganic porous aggregate, a relative permittivity of 2.0 or less can be obtained at a porosity of the dielectric layer 11 of approximately 20%. The thickness of the dielectric layer 11 can be designed as appropriate depending on the application. In a case where the reflector 10 is used in a flexible manner, the thickness of the dielectric layer 11 may be set to 0.3 mm or greater and 1.0 mm or less. By setting the thickness of the dielectric layer 11 to 0.3 mm or greater, the reflector 10 having a high robustness can be obtained. When the thickness of the dielectric layer 11 is set to 1.0 mm or less, it is advantageous for weight reduction in designing a large reflector having one side of approximately 1 m, and excellent workability and low installation cost can be achieved. The dielectric layer having the thickness of 0.3 mm, 1.0 mm, or the like includes a tolerable manufacturing error.

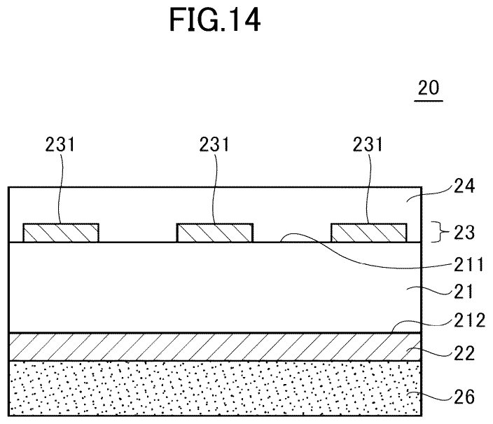

FIG. 14 is a schematic diagram of a reflector 20 according to a second embodiment. A main part of the reflector 20 is the same as that of the reflector 10 according to the first embodiment, and a dielectric layer 21 having a relative permittivity of 2.0 or less is used. A conductive layer 23 including predetermined conductive patterns 231 is formed on a first surface 211 of the dielectric layer 21, and a ground layer 22 is provided on a second surface 212. The conductive patterns 231 are designed so that a reflection direction of the main lobe with respect to the incident waves in the 28 GHz band is inclined at a predetermined angle from the normal direction, and have the pattern illustrated in FIG. 3A, for example. Hereinafter, the design of the target value of the reflection peak angle is varied to “−43°”, and analysis and evaluation are performed by simulation.

The protective layer 24 is provided to cover the conductive layer 23. An adhesive layer 26 is provided on the ground layer 22. The reflector 20 can be attached to a desired location, such as a wall surface, a ceiling, or the like by the adhesive layer 26. The protective layer 24 is transparent with respect to the incident waves of 24 GHz to 30 GHz. The protective layer is transparent with respect to the incident waves when a transmittance thereof is 60% or greater, preferably 70% or greater, more preferably 80% or greater, and even more preferably 90% or greater with respect to the incident waves. The protective layer 24 may be transparent to visible light. By providing the protective layer 24, the reflector 20 can be used by being attached to an outdoor bulletin board or a wall surface of a building. The board having the reflector 20 attached thereto may be suspended and used at a desired location.

The protective layer 24 protects the conductive patterns 231 of the reflector 20 from degradation or damage caused by external factors, and provides excellent durability. The conductive patterns 231 of the reflector 20 are subject to oxidative degradation due to aging, such as contact with oxygen or moisture in the atmosphere, and thus, particularly when using the reflector 20 outdoors, it is preferable to provide the protective layer 24 from a viewpoint of weather resistance. Even in an indoor environment, the protective layer 24 is preferably provided in the same manner as described above if the installation environment is susceptible to condensation or the like. The protective layer 24 preferably has a thickness of 0.1 mm or greater and 1.0 mm or less, and a relative permittivity of 2.0 or less. By configuring the protective layer 24 in this manner, it is possible to obtain the reflector 20 that is highly durable and also highly transparent to incident waves of 24 GHz to 30 GHz.

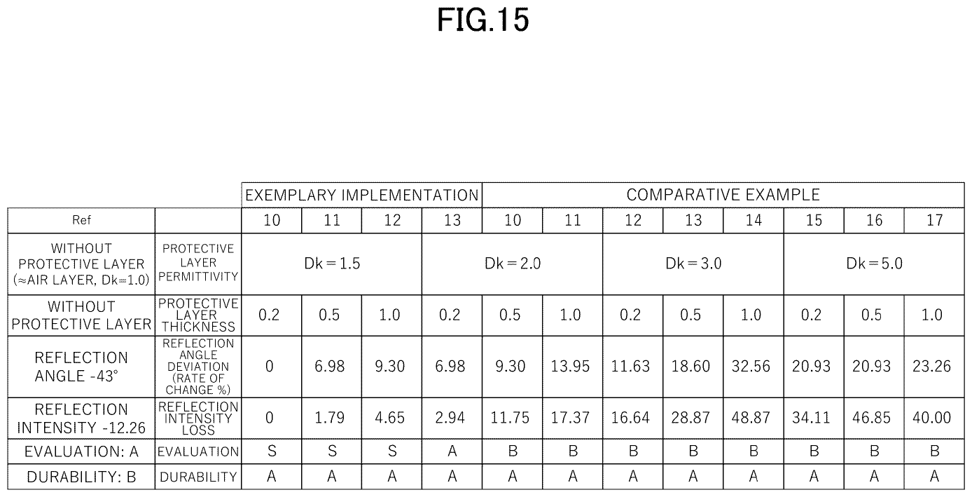

Using a model having the configuration of FIG. 14 excluding the adhesive layer 26, simulations were performed under the following conditions for exemplary implementations 10 through 13 and comparative examples 10 through 17 in which a thickness (mm) and a relative permittivity Dk of the protective layer are varied as illustrated in FIG. 15, and a reflection angle deviation (%) and a reflection intensity loss (%) of the exemplary implementations and the comparative examples were obtained from the far-field radiation region, the intensity, and the angle of the reflectance spectrum with respect to the incident waves.
Wavelength of incident waves: 10.7 mm (frequency of 28 GHz)
Frequency variation range of incident waves: from 20 GHz to 35 GHz
Incident angle of incident waves with respect to normal direction of reflector: 0 degree
First desired angle of reflection, θ of the reflectance spectrum with respect to the normal direction of the reflector: −43 degrees
Number of conductive patterns: 5 (series arrangement)
Pitch of conductive patterns: 5.35 mm
Relative permittivity of protective layer 24:1.0 (Ref), 1.5, 2.0, 3.0, 5.0
Thickness of protective layer 24:0.0 mm (Ref), 0.2 mm, 0.5 mm, 1.0 mm
   Five cross patterns having different sizes are used doe the shape of the conductive patterns, and the angle of reflection and the reflection intensity are calculated by varying the thickness and the relative permittivity of the protective layer 24 covering the conductive patterns.

FIG. 15 illustrates the results of the simulation. “Ref” in a leftmost column of FIG. 15 indicates a reference configuration not provided with the protective layer 24. In the reference configuration, because an air layer covers the conductive patterns, the thickness of the protective layer 24 is regarded to be 0.0 mm and the relative permittivity is regarded to be 1.0. The unit of the reflection intensity of the reference configuration is (dB). “Reflection angle deviation” indicates a rate of change (%) from the angle of reflection of the reference configuration, and “reflection intensity loss” indicates a percentage of decrease (%) from the reflection intensity of the reference configuration. The peak angle and the peak intensity of the main lobe with respect to the incident waves were compared between the reference configuration (Ref) and the exemplary implementations 10 through 13 and the comparative examples 10 through 17, and the reflection angle deviation (unit: %) and the reflection intensity loss (unit: %) were obtained. The reflection angle deviation and the reflection intensity loss were evaluated as follows.
Reflection angle deviation of 10% or less: A
Reflection angle deviation exceeding 10%: B
Reflection intensity loss of 5% or less: S
Reflection intensity loss of 10% or less: A
Reflection intensity loss exceeding 10%: B
Overall Evaluation

Qualified: Evaluations for both reflection angle deviation and reflection intensity loss are “A”

Disqualified: Evaluation of one of reflection angle deviation and reflection intensity loss is “B”

As illustrated in FIG. 15, the exemplary implementations 10 through 13 were qualified. In addition, in the exemplary implementations 10 through 12, the reflection intensity loss was small, and more preferable results were obtained. From FIG. 15, it can be observed that the reflection angle deviation and the reflection intensity loss are large when the relative permittivity Dk is high, and that the relative permittivity Dk is preferably 2.0 or less. The relative permittivity Dk is more preferably 1.5 or less, because the reflection intensity loss becomes 5% or less (evaluated as “S” in FIG. 15). When the thickness of the protective layer 24 is large, the reflective angle deviation and the reflective intensity loss are large, and the thickness of the protective layer 24 is preferably 0.1 mm or greater and 1.0 mm or less.

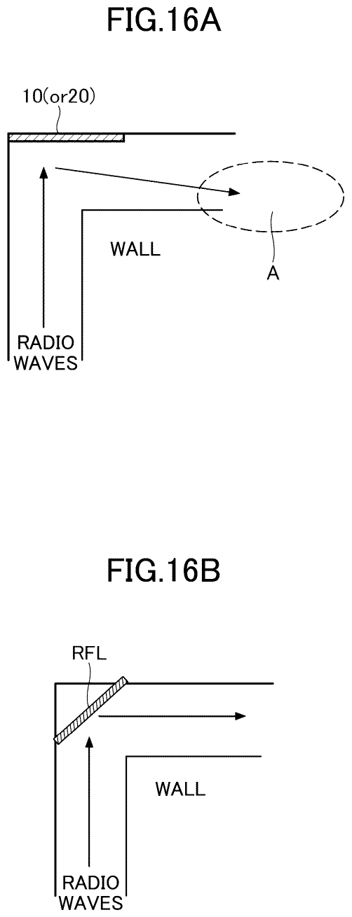

FIG. 16A illustrates an example of use of the reflector 20 according to the embodiment. FIG. 16B illustrates an example of use of a standard reflector for comparison. FIG. 16A illustrates a usage mode of the reflector 10 or 20 according to the embodiment. The reflector 10 or 20 according to the embodiment, which is thin and flexible, can be installed along an L-shaped curved passage, a street, a corridor, or the like.

The reflector according to the embodiment has the metasurface including the cyclic array of the plurality of conductive patterns 131, and reflects the incident waves in directions other than specular reflection. As illustrated in FIG. 16A, in a case where radio waves are vertically incident on the reflector 10 or 20 installed on the wall surface at a corner, the incident radio waves are reflected at an oblique angle other than the vertical and horizontal directions of the reflector. Hence, it is possible to transmit the radio waves to smartphones, electronic devices, lighting devices, or the like located in a region A.

As illustrated in FIG. 16B, a standard reflector RFL having a specular reflecting surface reflects vertically incident radio waves in the incident direction. For this reason, the reflector RFL must be installed at an oblique angle with respect to the incident radio waves. When the reflector is installed at the corner as illustrated in FIG. 16B, space cannot be utilized efficiently. In contrast, the reflector 10 or 20 according to the embodiment can reduce a dead zone of the radio waves without taking up space and without impairing appearance thereof.

As described above, the reflector according to the embodiment can expand the reflection frequency bandwidth and improve the resistance to the environment, by using the dielectric layer having a low relative permittivity. In addition, the thickness of the reflector can be reduced for the same reflection frequency characteristic, thereby expanding the application range. In a case where the reflector is formed in a wallpaper shape, the surface of the adhesive layer 26 may be protected with a protective film, and the protective film may be removed from the reflector upon use when attaching the reflector to a desired place. The reflector according to the embodiment may be used in combination with a small cell or a relay (repeater). In this case, the dead zone can further be reduced without increasing the number of devices, such as the small cells, the repeaters, or the like, and without taking up space for installing the reflector.

The present disclosure may be implemented by the following numbered clauses.

### (Clause 1)

A reflector comprising:
a dielectric layer;
a conductive layer formed on a first surface of the dielectric layer and including a plurality of conductive patterns that reflect incident waves; and
a ground layer formed on a second surface of the dielectric layer opposite to the first surface, wherein:
the plurality of the conductive patterns is disposed along a predetermined direction, and
a standard deviations σ of a difference between an ideal distance and a center-to-center distances between centers of a reference conductive pattern and an arbitrary conductive pattern among the plurality of conductive patterns on a straight line along the predetermined direction is 0.5 mm or greater and 1.5 mm or less.

### (Clause 2)

The reflector according to clause 1, wherein:
in a case where in-phase incident waves are incident on the reference conductive pattern and an m-th conductive pattern counted from the reference conductive pattern among the plurality of conductive patterns, the center-to-center distance between the reference conductive pattern at which the intensity of the reflected wave is highest and the m-th conductive pattern is defined as an ideal distance dm of the m-th conductive pattern,
the center-to-center distance between the reference conductive pattern and the m-th conductive pattern formed on the first surface of the dielectric layer is defined as an actual distance dm′ of the m-th conductive pattern,
an absolute value of a difference between the actual distance dm′ and the ideal distance dm is defined as |dm′−dm|, where m is an integer which is 1 or greater, and
a standard deviation of a group of |dm′−dm| of the conductive patterns other than the reference conductive pattern is 0.5 mm or greater and 1.5 mm or less.

### (Clause 3)

The reflector according to clause 1, further comprising:
an adhesive layer provided on a surface of the ground layer on an opposite side from the dielectric layer.

### (Clause 4)

The reflector according to clause 1, further comprising:
a protective layer covering the conductive layer.

### (Clause 5)

The reflector according to clause 4, wherein the protective layer has a thickness of 0.1 mm or greater and 1.0 mm or less, and a relative permittivity of 2.0 or less.

### (Clause 6)

The reflector according to clause 1, wherein the dielectric layer has a thickness of 0.3 mm or greater and 1.0 mm or less.

### (Clause 7)

The reflector according to clause 1, wherein the plurality of conductive patterns have a length of 2.0 mm or greater and 5.0 mm or less, respectively.

### (Clause 8)

The reflector according to clause 1, wherein a reflection frequency bandwidth per unit thickness of the reflector is greater than 6.5 GHz/mm.

### (Clause 9)

The reflector according to any one of clauses 1 to 8, wherein the dielectric layer is formed of bonded structure of a fluoropolymer and an inorganic porous aggregate, and the dielectric layer has a porosity of 20% or greater.

This application is based upon and claims priority to Japanese Patent Application No. 2023-058657, filed on Mar. 31, 2023 before the Japan Patent Office, the entire contents of which are incorporated herein by reference.

### DESCRIPTION OF REFERENCE NUMERALS

10, 20: reflector
11, 21: dielectric layer
111, 211: first surface
112, 212: second surface
12, 22: ground layer
13, 23: conductive layer
131, 231: conductive pattern
24: protective layer
26: adhesive layer

1. A reflector comprising:
a dielectric layer;
a conductive layer formed on a first surface of the dielectric layer and including a plurality of conductive patterns that reflect incident waves; and
a ground layer formed on a second surface of the dielectric layer opposite to the first surface, wherein:
the plurality of the conductive patterns is disposed along a predetermined direction, and
a standard deviations σ of a difference between an ideal distance and a center-to-center distances between centers of a reference conductive pattern and an arbitrary conductive pattern among the plurality of conductive patterns on a straight line along the predetermined direction is 0.5 mm or greater and 1.5 mm or less.

2. The reflector as claimed in claim 1, wherein:
in a case where in-phase incident waves are incident on the reference conductive pattern and an m-th conductive pattern counted from the reference conductive pattern among the plurality of conductive patterns, the center-to-center distance between the reference conductive pattern at which the intensity of the reflected wave is highest and the m-th conductive pattern is defined as an ideal distance dm of the m-th conductive pattern,
the center-to-center distance between the reference conductive pattern and the m-th conductive pattern formed on the first surface of the dielectric layer is defined as an actual distance dm′ of the m-th conductive pattern,
an absolute value of a difference between the actual distance dm′ and the ideal distance dm is defined as |dm′−dm|, where m is an integer which is 1 or greater, and
a standard deviation of a group of |dm′−dm| of the conductive patterns other than the reference conductive pattern is 0.5 mm or greater and 1.5 mm or less.

3. The reflector as claimed in claim 1, further comprising:
an adhesive layer provided on a surface of the ground layer on an opposite side from the dielectric layer.

4. The reflector as claimed in claim 1, further comprising:
a protective layer covering the conductive layer.

5. The reflector as claimed in claim 4, wherein the protective layer has a thickness of 0.1 mm or greater and 1.0 mm or less, and a relative permittivity of 2.0 or less.

6. The reflector as claimed in claim 1, wherein the dielectric layer has a thickness of 0.3 mm or greater and 1.0 mm or less.

7. The reflector as claimed in claim 1, wherein the plurality of conductive patterns have a length of 2.0 mm or greater and 5.0 mm or less, respectively.

8. The reflector as claimed in claim 1, wherein a reflection frequency bandwidth per unit thickness of the reflector is greater than 6.5 GHz/mm.

9. The reflector as claimed in claim 1, wherein the dielectric layer is formed of bonded structure of a fluoropolymer and an inorganic porous aggregate, and the dielectric layer has a porosity of 20% or greater.
